(19) United States
(12) Patent Application Publication
(10) Pub. No.: US 2013/0275120 A1
(43) Pub. Date: Oct. 17, 2013

(54) Process for a Signified Correct Contextual Meaning Sometimes Interspersed with Complementary Related Trivia

(71) Applicant: Lee Michael DeGross, Fort Lee, NJ (US)

(72) Inventor: Lee Michael DeGross, Fort Lee, NJ (US)

(21) Appl. No.: 13/861,371

(22) Filed: Apr. 11, 2013

Related U.S. Application Data
(60) Provisional application No. 61/632,833, filed on Apr. 11, 2012.
(60) Provisional application No. 61/635,871, filed on Apr. 20, 2012.

(51) Int. Cl. G06F 17/28

(52) U.S. Cl. CPC G06F 17/28
USPC 704/9

(57) ABSTRACT

A process for displaying a signified correct contextual meaning for a word or phrase having two or more meanings. A user selects the word in a sentence on a computer screen which instantly triggers a nearby pop-up space. The pop-up space presents the two or more meanings of the selected word and one of the meanings is the correct contextual meaning and is encircled, for example. The signified correct contextual meaning is from the work and expertise, for example, of writers or editors. The two or more meanings in the pop-up space can be definitions, other reference materials, pictures, videos, or other meanings. Sometimes a complementary related trivia is presented to enliven the learning experience. The complementary trivia can be related, for example, to the selected word, to the associated information displayed on the screen, or to the pop-up space meanings. The educational process helps a person learn about the correct contextual meaning for words or phrases with two or more meanings, and the fun trivia enlivens the experience.

### CROSS-REFERENCE TO RELATED APPLICATIONS

This application claims the benefit of provisional patent application Ser. No. 61/632,833, filed 2012 Apr. 11, and provisional patent application Ser. No. 61/635,871, filed 2012 Apr. 20 by the present inventor.

### FEDERALLY SPONSORED RESEARCH

Not applicable

### SEQUENCE LISTING OR PROGRAM

Not applicable

### BACKGROUND

1. Field

This application relates to the field of computers, specifically to educational digital multimedia processes.

2. Description of Prior Art

The less relevant prior art will be discussed first and will progress to the more significant prior art. For purposes of brevity, the word “selection”, “selecting”, “selects”, and “selected” encompasses all of the various selection methods of a computer. These selection methods include stylus, keyboard, mouse click, touchscreen, and other selection tools.

Pop-up spaces are frequently encountered when using computer software applications. Many functions in software are represented by a graphical icon meant to make it easy to recognize its meaning. For example, in Microsoft Word™, a popular word processor program, when the cursor is placed over the yellow folder icon, the word “Open” pops up next to it.

More examples of pop-ups from Microsoft Word™ includes the brush icon which results in the “Format Painter” pop-up, the italicized “ABC” icon with a checkmark which results in the “Spelling and Grammar” pop-up, and the “can of spilling paint” icon which results in the “Fill Color” pop-up.

A major reason these pop-ups are used is to save space. These pop-ups are minor prior art. The limitations of these pop-ups are obvious. They merely serve as a labeling technique for the icons.

The next prior art is the dictionary function of Microsoft Word™. The fastest sequence requires selecting a word, the right-click, which yields a pop-up menu having a “Look Up . . . ” choice, and its selection causes a tall research column to appear top to bottom on the right outside of the word processor page, layout, or window. The column shows the dictionary information for the selected word, an input box for entering words, a drop-down menu of various dictionary and thesaurus titles, a translation feature, and various research, business, and financial website links for selection.

A disadvantage of the dictionary function is its slowness and unwieldiness. At least two selecting actions are needed to get the dictionary information for a word. The pop-up menu is unwieldy because it has 11 other choices and most are word processing functions.

Another disadvantage is the absence of a pop-up space with the dictionary information near the selected word. The user is forced to divert his or her attention from the literature and look to the right edge of the computer screen. Another disadvantage is that the research column takes up valuable screen space, almost a quarter of it.

Another disadvantage is that the research column does not immediately provide images such as drawings, photographs, comics, animation, videos, cartoons, movies, computer generated imagery, and 3-dimensional imagery for the selected word.

The last described disadvantage of Microsoft Word™ is particularly inherent with word processors. When there are more than one dictionary definitions for a selected word, the correct contextual definition is not signified. Instead the same dictionary results are given for the same selected word. If a sentence is using a particular definition for the selected word and there are several different definitions displayed, it would not be indicated to a user. The democratic dictionary function of Microsoft Word™ gives no clue as to which of the selected word's multiple different definitions is the correct one in the context of a sentence.

The next prior art are the products, services, patent applications, and issued patents that provide computerized disambiguation of ambiguous terms. These share some common features and are utilized in 2 major categories, which are search engines and translation services. For search engines, ambiguous terms need to be disambiguated in order to return relevant search results. For translation services, ambiguous terms need to be disambiguated to get a corresponding translated term with the same meaning. The point is to avoid a translation of the other wrong meanings of the ambiguous term.

The common features of the search engines and translation services are user inputs of words and the use of context information around the ambiguous term such as words, text, and images. Another common feature is the complicated techniques, parts, functions, and methods to get the disambiguated meaning. For example, the use of tables, weighted values, indexes, tags, rankings, percentages, probabilities, classifying groups of words or documents, establishing similarities of words or documents, a user's previous stored activities, syntax and grammar rules, and part of speech types are just a few mentioned.

A disadvantage of the computerized disambiguation is their output of merely the most likely, the most accurate, the highest ranked or the highest probability result. When a word within a sentence has several meanings, the computerized disambiguation fails to indicate the absolute correct contextual meaning of the word.

Since the computerized disambiguation provides automated and system results, this is another disadvantage because such results are not from the work of writers, editors, producers, or an editorial staff.

The next prior art is U.S. patent application Ser. No. 10/323,042 entitled “Graphical feedback for semantic interpretation of text and images”. The application describes a method for the disambiguation of a selected text or image when the system indicates it has at least two alternative interpreted meanings. A user selects one of the rank ordered alternative interpreted meanings. If there is no user selection, the system has an interpreter function with an “opinion” that displays first on a list what it “thinks” is the “best choice” alternative interpreted meaning. The list is based on the surrounding context information and the use of ontology database analysis and other complicated hierarchical techniques.

A disadvantage of the system is that it relies on the user to verify the first listed interpreted meaning, or to choose a correct alternative interpreted meaning. Another disadvantage is if the user chooses an alternative interpreted meaning that is not the first listed, this is no guarantee as to its correctness. Another disadvantage is that it can return no correct alternative interpreted meanings for the user to choose.

In the embodiments without user input, a disadvantage is the interpreter function with its “opinion” on what it “thinks” is the “best choice”. The method fails to indicate the absolute correct contextual meaning of the ambiguous selected term.

The method can even be unable to interpret the text, and this is another disadvantage.

Another disadvantage of the application is that it does not describe any dictionary, any definitions, any dictionary senses, or even any other reference materials such as a thesaurus and its synonyms.

The next prior art is U.S. Pat. No. 8,250,071 entitled “Disambiguation of term meaning”. The patent describes enhancing a user's interaction with terms for example, in ebooks, and methods for improving reading comprehension. The user may highlight to select a term to get its meaning, query and store the term, get the term disambiguated, annotate the term, view term usage examples from a corpus of books, get improved search query results from disambiguation techniques, interact with other users, use blogging features, and be tested about the term from vocabulary questions or in a vocabulary game.

A disadvantage of the patent is that the disambiguation function ranks possible meanings of the selected term, then determines a highest ranking meaning as the top ranking meaning and presents it to the user. The rankings are based on the metadata of each meaning and the metadata of the ebook, or perhaps the metadata of other ebooks.

The use of automated rankings with its highest ranking meaning provides uncertain results, and this is a disadvantage. The method fails to indicate the absolute correct contextual meaning of the ambiguous selected term.

Another disadvantage of the patent is that it does not describe any photographic, animation, or video imagery contained in a pop-up space that conveys a meaning for a selected word or phrase.

Another disadvantage is that it uses trivia specifically to test a person's knowledge of the specific vocabulary terms. A further disadvantage is that it describes various game versions to also use the trivia specifically to test a person's knowledge of the specific vocabulary terms. The testing and the game versions of testing are a disadvantage because they are very developed, tediously insistent, and onerous tasks that likely take away any sense of fun. If fact the descriptions on the testing and game versions of testing overwhelm and take precedence over the patent's primary method as referred to in its title “Disambiguation of term meaning”. Another disadvantage is that it does not describe any tranquil, amusing non-interactive trivia.

A disadvantage, with the exception of the preceding patent, of the above prior art references is that they do not provide any fun trivia to enliven the learning experience.

The next prior art is called “SuperMunchers Trivia” which is available on a CD-ROM. This computer trivia game combines arcade action and trivia questions. Players must control their Munchers and munch the answer to questions while evading Troggles, who can eat the Munchers. A player's trivia knowledge is tested by munching as many answers as it can. The disadvantage is that the trivia game does not have any educational content such as dictionary entries.

The next prior art are the patents and patent applications in the Information Disclosure Statement about different computer trivia versions. The disadvantage of these trivia versions is that none describe or teach the absolute correct contextual meaning of ambiguous words and any dictionary entries.

This concludes the prior art section.

### SUMMARY

A convenient process for enabling a person to see a contextual meaning of a word or phrase in a sentence displayed on a computer screen. When the person selects the word, a pop-up space instantly appears nearby presenting the two or more meanings of the selected word. The two or more meanings can be dictionary entries such as pronunciations, parts of speech, definitions, senses, and quotations. The two or more meanings can be images or moving images such as drawings, comics, photographs, animations, movies, and videos. One of the meanings is the correct contextual meaning and is distinctly signified. A complementary related trivia can be presented. The complementary trivia can be related, for example, to the selected word or the pop-up space meanings, and can be presented in many possible formats. The pop-up space meanings and complementary related trivia can be calibrated for audiences of different ages, or customized for different occupations. The results provide educational, learning, and informative benefits.

### DRAWINGS—FIGURES

FIG. 1 shows a computer.

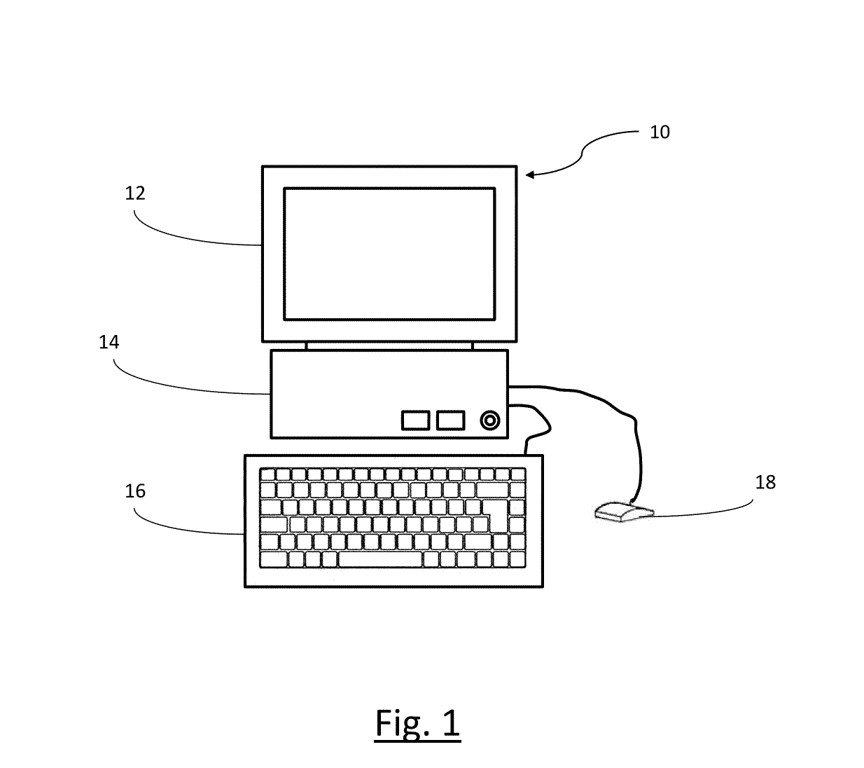

FIG. 2 shows web browser features with a cursor over the signaled word “cat” and a non-interactive complementary related trivia.

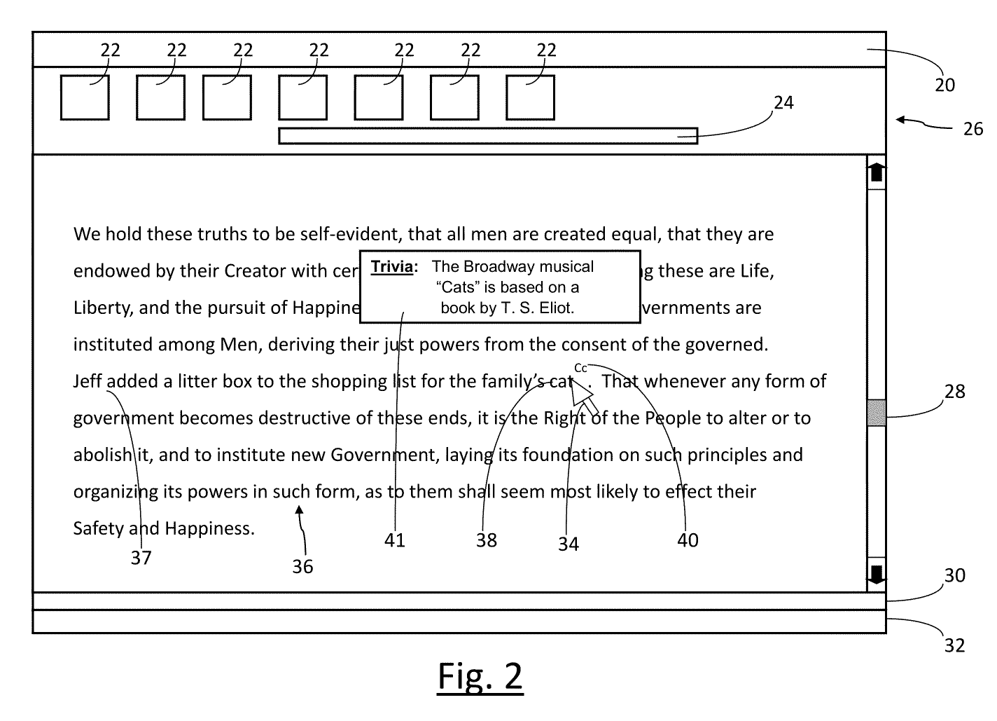

FIG. 3 shows a pop-up space nearby presenting content of at least two meanings with the correct contextual meaning signified.

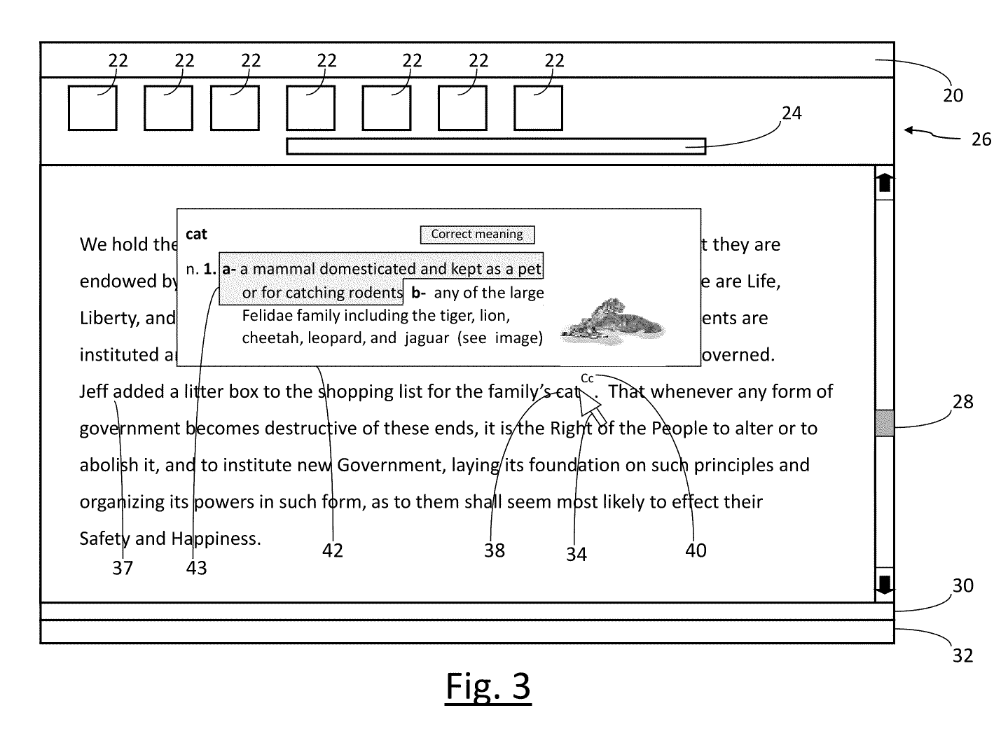

FIG. 4 shows a cursor over the word “superconductor”.

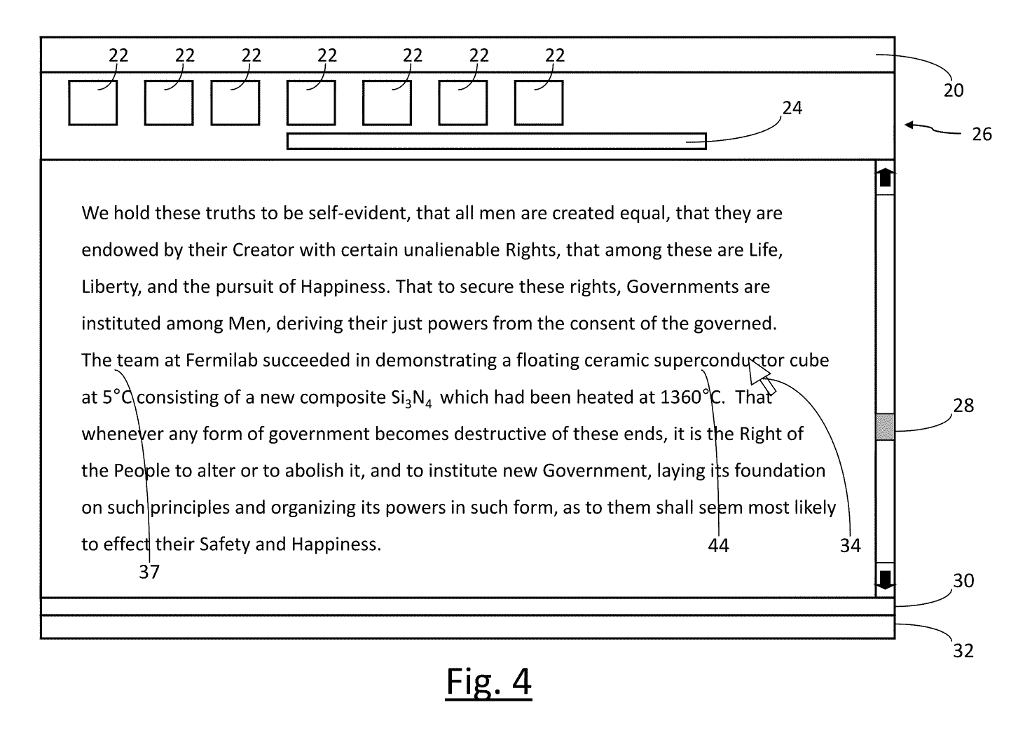

FIG. 5 shows a pop-up space nearby presenting at least two meanings with the correct contextual meaning highlighted and an interactive complementary related trivia.

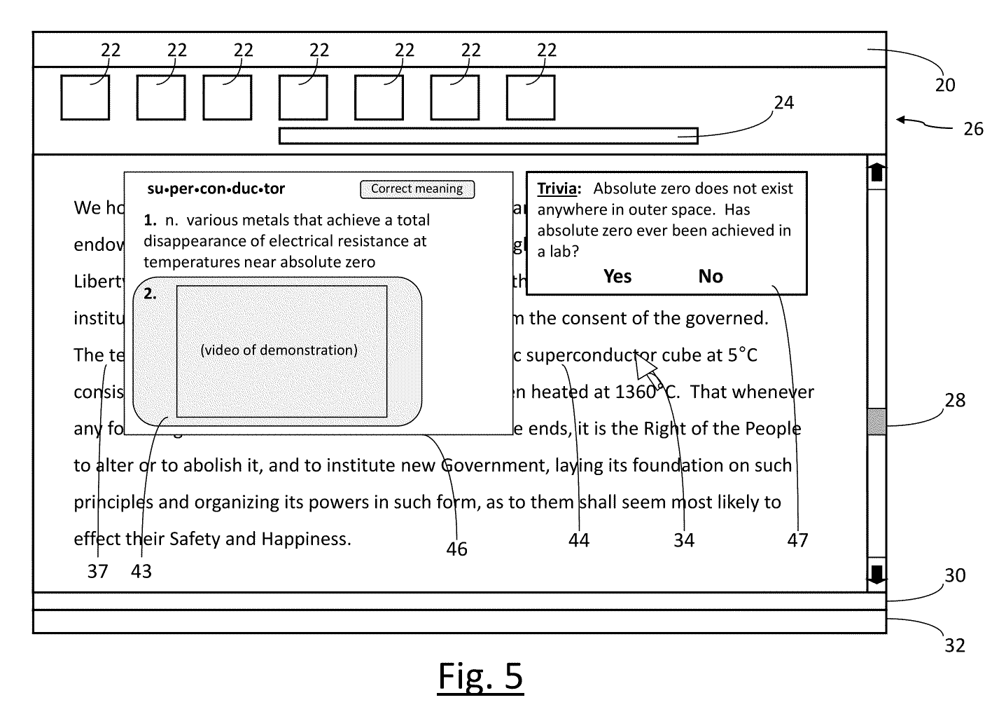

FIG. 6 shows a cursor over the word “climb” and an interactive complementary related trivia.

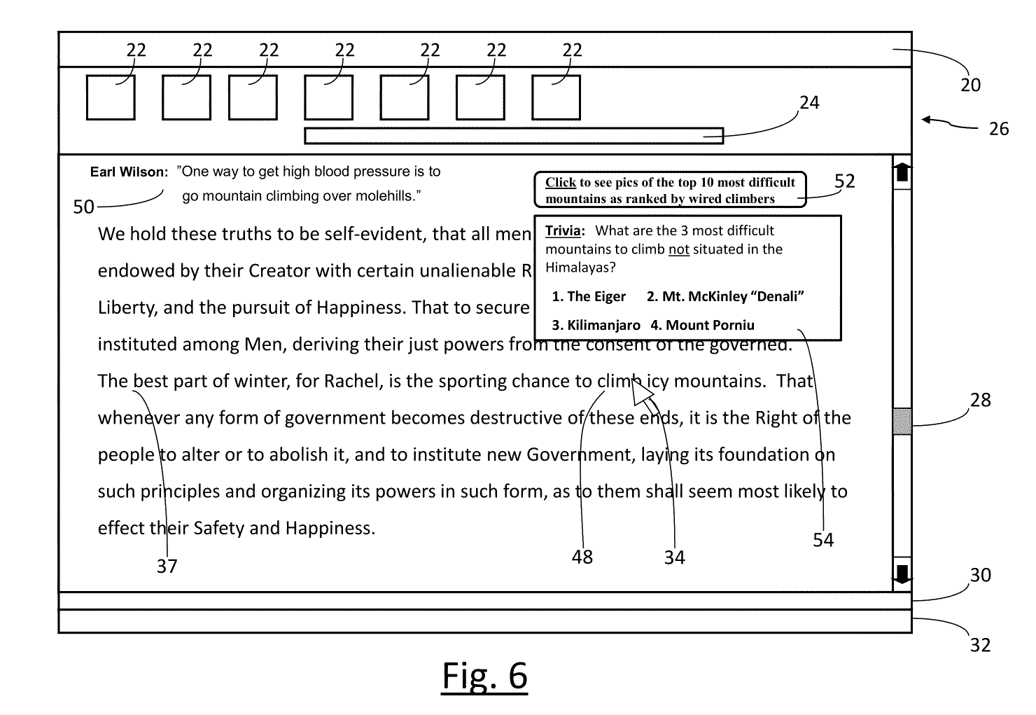

FIG. 7 shows a pop-up space nearby presenting at least two meanings with the correct contextual meaning distinctly encircled and an interactive complementary related trivia.

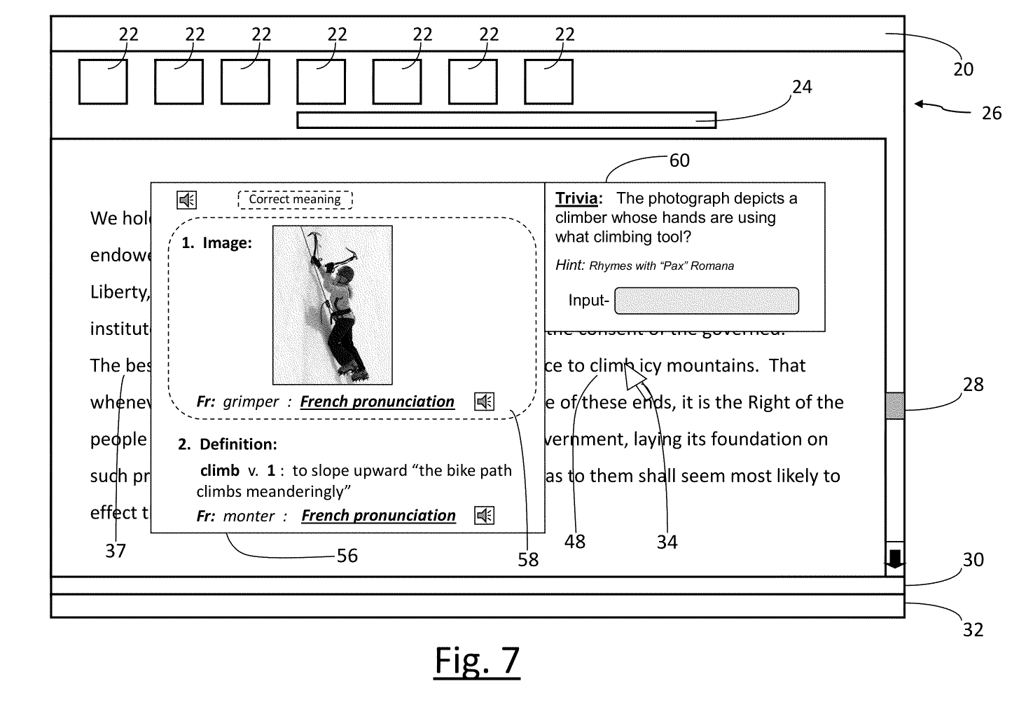

### DRAWINGS—REFERENCE NUMERALS

| | | | |
|---|---|---|---|
| 10 | computer | 12 | screen |
| 14 | central processing unit | 16 | keyboard |
| 18 | mouse | 20 | web browser menu bar |
| 22 | web browser buttons | 24 | Uniform Resource Locator field |
| 26 | web browser features | 28 | scroll bar |
| 30 | web browser bar | 32 | operating system bar |
| 34 | cursor over a word | 36 | text on the screen |
| 37 | sentence | 38 | “cat” word |

| | |
|---|---|
| 40 | special distinguishing signal of “^{Cc}” |
| 41 | non-interactive format of a complementary trivia from an extemporaneous work |
| | source related to “cat” word of part 38 |
| 42 | pop-up space presents reference materials of a dictionary main entry “cat”, a |
| | part of speech “n.”, a definition, the definition's two senses, and an image for |
| | the second sense. The correct contextual meaning is signified as highlighted, |
| | which is the first sense. |
| 43 | signify function of a color highlight |
| 44 | “superconductor” word |
| 46 | pop-up space presents the dictionary entries of a main entry “superconductor” |
| | with word divisions, a part of speech “n.”, a definition, and a moving image as |
| | indicated by “(video of demonstration)” is the final meaning. The correct |
| | contextual meaning is the 1^{st} definition, which is highlighted. |
| 47 | interactive complementary trivia with yes or no format related to 1^{st} definition of |
| | part 46 |
| 48 | “climb” word |
| 50 | quotation as an associated information to “climb” word of part 48 |
| 52 | clickable link as an associated information to “climb” word of part 48 |
| 54 | interactive complementary trivia to select 3 right answers format related |
| | to associated information of part 52 |
| 56 | pop-up space presents a speaker icon. When it is selected, the computer |
| | produces the sound meanings of a narration or an exact audio reading of the |
| | pop-up space's contents. The pop-up space presents a 1^{st} image meaning. A |
| | different language word is presented, which is “grimper” the French word for |
| | this 1^{st} meaning of climb. A 1^{st} selectable “French pronunciation” with a speaker |
| | icon is shown for the French pronunciation sound of “grimper”. Next is the 2^{nd} |
| | meaning of a definition and the dictionary entries of a main entry “climb”, a part |
| | of speech “v.”, and a definition. The French word “monter” is presented for this |
| | 2^{nd} meaning of climb. A 2^{nd} selectable “French pronunciation” with a speaker |
| | icon is shown for the French pronunciation sound of “monter”. The correct |
| | contextual meaning is distinctively encircled, which is the image |
| 58 | signify function of a distinctive encircled dashed line |
| 60 | interactive complementary trivia with a hint and an input field format related to |
| | the correct contextual 1^{st} image meaning of part 56 |

### DETAILED DESCRIPTION AND OPERATION—FIRST EMBODIMENT

The title “Process for a Signified Correct Contextual Meaning Sometimes Interspersed with Complementary Related Trivia”, is hereinafter abbreviated, “CorrectContextual”. The CorrectContextual is a computer and internet creation that is a process, method, and a system. The purpose of the CorrectContextual is for enabling an educational, learning, and informational process that displays a signified correct contextual meaning for a word or a phrase having multiple meanings. A stimulating, complementary related trivia can also be presented. The process is fast, convenient, and fun for a person to use.

First a static physical description of a computer and the internet will be discussed. The computer is an ubiquitous machine that has undergone constant changes in form, speed, and memory size and this will continue as computers evolve presently and in the future. Computers come in all shapes and sizes but share four essential characteristics consisting of the digital input, processing, memory, and output functions.

Computers range in size from small hand-size personal digital assistants (PDA's) to a briefcase-like laptop PC (personal computer) to a typical desktop PC (personal computer). Larger computers like workstations and mainframes do not count for the CorrectContextual because their size is inappropriate for the intended audience of everyday computer and internet users.

The selection methods of the computer include and are not limited to a keyboard, mouse, touchscreen, touchpad, touch-button, stylus, and voice recognition. Two of the fastest selection methods are placing the cursor over the figurative expression without clicking it, or using the touchscreen method without a stylus.

The largest computer category (the desktop) will be described first and continue downwards in size to the PDA's. The categories mentioned are the prevalent ones and the computer is not limited to those described.

The desktop PC (or microcomputer) looks like a television screen sitting atop a square-looking slab about the size of a small suitcase. The television screen is actually a computer monitor and its screen is the primary output device. The screen shows multimedia text and images. The slab-like box, known as the Central Processing Unit (CPU), houses the processing and memory devices. It is often placed for example somewhere else on the desk or on the floor.

Positioned in front of the monitor or CPU is a flat slab with many buttons called a keyboard. The keyboard is an input device that that is used for typing to enter letters, numbers, characters, other symbols, and for maneuvering on the screen.

The mouse is another input device commonly used with desktop computers and is usually the size of a person's palm. The mouse is placed on a flat surface like a desk so that when a user moves it, the pointer or cursor on the screen moves correspondingly. The mouse often has a few buttons and other features. These features are a means, for example, for the pointer or cursor to draw, insert, point, select, choose, and “click on” a particular spot on the screen.

The last major desktop device, the printer (not shown), is an output device that comes in all shapes, sizes, and types. The average printer is typically a laser printer shaped like a medium-sized moving box. The printer's function, as the name implies, is to print or produce the hard copy (paper) output of the computer. The printer, though not essential to the CorrectContextual, is included for the sake of thoroughness.

The laptop (not shown), by now a very common machine, combines all of the features and devices of the desktop PC system (with the current exception of a printer) into one single unit. It is typically the size of a large notebook. Laptops are designed to be a portable PC with a very thin monitor and screen that, when closed, is usually positioned face down on the keyboard. A hinge or other similar device typically combines the keyboard and monitor, and the laptop looks like an open clamshell when opened.

Tablets (not shown) and the similar ereaders have the portability of laptops but are smaller with their screens taking up almost all their physical frames. They are typically extremely thin, many are less than an inch thick, and are more or less 9 square inches in size in a rectangular shape. The devices may have a cover or even a clamshell cover but the majority do not. Many tablets and ereaders use the touchscreen as the primary selection method. Tablets use most of the same software and internet applications as the desktop and laptop. Ereaders are for reading electronic books or ebooks, and most tablets also have this capability. Many ereaders use other software and internet applications. Tablets and ereaders often have special software tailored to their unique screen dominated shape and small light size. For example, the screen contents can easily switch 90 degrees to a total of 360 degrees, and easily slide to the next window or ebook page.

Personal digital assistants (PDA's) (not shown) are portable devices designed to be small enough to fit in a human's hand or shirt pocket. Many PDA's are pen-based, meaning that a pen-like stylus is used to do the input functions of the keyboard and mouse by touching the PDA's monitor. PDA's often have organizing functions that allow a person to do scheduling, act like a notepad, store information, calculate, and use many software applications for many other uses.

PDA's, including the tablets and ereaders, can be combined with various other electronic gadgets (not shown) that includes and is not limited to cell phones, pagers, gaming devices, GPS devices, and the like. Cell phones are portable wireless telephones. Pagers are small devices that alert the person to return a call, or receive and send a message. Gaming devices are handhelds that play computer games of all kinds. GPS devices are global positioning systems that provide advanced navigation, location, and mapping features. Any PDA that exhibits multimedia text and images is relevant to the CorrectContextual.

For PDA's accessing an internet website, the screen typically shows just a portion of the website. The PDA's screen can get the rest of the website by using a scrolling function to go across, or up and down. The PDA's monitor can even display 100% of a website's contents on its small screen. PDA's, including tablets and ereaders, can show a digital keyboard on their screens for inputting functions.

Some desktops, laptops, tablets, ereaders, and PDA's are segments of a broader computer system because they have one or more limited or partial computer components (not shown). The segments can entirely lack the one or more computer components. The components includes and is not limited to hard drives, CPUs, monitors, screens, memories, keyboards, batteries, and internet connectivity.

Some desktops, laptops, tablets, ereaders, and PDA's can have detachable components (not shown) such as a screen. The detached component can be attached to another computer.

All of the computer categories can have peripheral devices (not shown). The peripheral devices includes and is not limited to extra monitors, extra screens, external hard drives, internal hard drives, CD and DVD drives, CDs, DVDs, speakers, portable audio and video recorders, portable PDA and handheld devices, cameras, video projectors, televisions, game devices, flash drives, flash cards, credit and debit card machines, and even cash registers.

Virtually all desktops, laptops, tablets, ereaders, and PDA's can access the internet and an intranet, often by wireless means. The computers are powered using an electrical outlet, sometimes in combination with batteries which are usually rechargeable, or only the batteries.

The internet and the intranet will now be described. The idea of the internet is simple, a vast network of computers of many types that are connected and interact with one another. The whole of the internet could probably be written about in a series of large books.

The following definition of the internet is from the IBM Dictionary of Computing. It defines the internet as, “A wide area network connecting thousands of disparate networks in industry, education, government, and research. The Internet network uses TCP/IP as the standard for transmitting information.”

The TCP/IP is defined by the same dictionary as, “Transmission Control Protocol/Internet Protocol. A set of communication protocols that support peer-to-peer connectivity functions for both local and wide area networks.”

The internet spans many countries, consists of thousands of networks, has millions of users, and will continue to grow and improve. The most relevant feature regarding the internet is the World Wide Web (WWW), with its ability to handle graphics, multimedia, and hypertext links.

The WWW is navigated or surfed with the help of a web browser. A website's address is accessed when its URL (Uniform Resource Locator) or domain name is invoked on the browser's domain name locator. For WWW websites, their address begins with the prefix “www” as in www.websitename.com. The suffix “.com” is a government-created categorization representing the commercial industry. Other examples of these suffixes are “.net”, “.org”, “.edu”, “.mil” and “.gov”. More such suffixes will undoubtedly be created.

The CorrectContextual is not limited to the WWW, and can be implemented on internet sites without the WWW. It can also utilize and be implemented on internet/television hybrids (not shown).

The CorrectContextual can be implemented on intranet websites. The following definition of the intranet is from the Dictionary of Computer and Internet Terms. It defines the intranet as, “the opposite of INTERNET, a network confined to a single organization (but not necessarily to a single site). Intranets often include web pages, so a web browser can be used to view the content. This makes the intranet appear just the same as part of the World Wide Web, the only difference is that it is not accessible to those outside the organization. Keeping it separate from the outside world is essential if it carries confidential data, such as internal business records.”

However, it must be re-emphasized that the CorrectContextual is also applicable to computers and software applications that are independent or offline of the internet and the intranet.

The CorrectContextual is not limited as to the type of computer on which it runs, and not limited as to the type of network used. This concludes the basic description of the computer hardware, the internet, and the intranet.

Next is a static description of the words or phrases. The CorrectContextual is useful wherever there are words or phrases displayed on a computer screen that have more than one meaning. Examples of phrases are “circulatory system”, “technical foul”, “alternative fuels”, “relative atomic mass”, and “environmental impact statement”. The words or phrases are hereinafter “word” or “words”.

The words are in a sentence, a text, a literature, or associated information on the computer screen. The sentence, text, and literature are commonplace and are easy to conceptualize. For the associated information, an easy example is a medical website displaying varied information. The website shows words with more than one meaning, quotations, links, drop-down menus, images, literature in 5 separate sections and columns, statistics, 2 search fields, and a video that can be played.

The CorrectContextual operates when a user simply selects or places a cursor over the word on the computer screen. This triggers a pop-up space that appears, preferably nearby, that presents more than one meaning or at least two meanings about the selected word. One of the meanings is the correct and intended contextual meaning and is signified. The correct meaning depends on the context in which the word is used in a sentence. The correct contextual meaning signified is based on the work and expertise of writers, editors, editorial staff, copy-editors, proofreaders, producers, directors, web masters, designers, or programmers to name a few. The optional complementary related trivia can be presented.

The words can indicate that there is a latent pop-up space for them with a special signaling feature, such as the symbol “♦.” placed on or next to the words. To further distinguish the signal, it can be colored red, for instance.

The pop-up space itself need not always be a strictly rectangular or window shape. The pop-up space can take many forms, shapes, and sizes. The pop-up space includes and is not limited to overlapping spaces, multiple pop-up spaces, 3 dimensional spaces, spaces that look like billowy clouds, and other spatial images that serve as pop-up spaces.

The pop-up space meanings can include and are not limited to dictionary entries, words, phrases, terms, sentences, text, paragraphs, pages, persons, people, subjects, other reference materials, and visual information such as images and moving images about the selected word.

The dictionary entries can include and are not limited to main entries, definitions, senses, word divisions, parts of speech, pronunciations, syllable breaks, variants, synonyms, antonyms, etymologies, usages, idioms, homographs, suffixes, prefixes, inflected forms, example sentences, and quotations. These are merely the prominent examples of the many entries of a dictionary.

More examples of the dictionary entries are binomials, cognate cross-references, directional cross-references, synonymous cross-references, inflectional cross-references, functional labels, stylistic labels, capitalization labels, subject labels, temporal labels, regional labels, lightface types, major stresses, minor stresses, centered periods, run-on entries, small capitals, usage notes, and verbal illustrations.

The other reference materials can include are not limited to almanacs, encyclopedias, compilations, summaries, reviews, criticism reviews, treatises, maps, and directories.

The pop-up space can contain images and imagery that convey a meaning for the selected word, or the other pop-up space meanings (not shown), or the optional related trivia (not shown). The images includes and are not limited to drawings, illustrations, pictures, photographs, comics, paintings, charts, maps, diagrams, 3 dimensional images, and digital photographs.

The pop-up spaces can contain moving, movement, action, and motion images and imagery that convey a meaning for the selected word, or the other pop-up space meanings (not shown), or the optional related trivia (not shown). The moving images includes and are not limited to animation, films, movies, videos, cartoons, claymation, stop-action imagery, 3 dimensional action works, digital video works, and computer generated action images.

The pop-up space can contain images or moving images that include and is not limited to renderings of ideas, concepts, processes, thinking, thoughts, spatial motions, immaterial things, metaphysics, stories, plays, plots, tales, enactments, reenactments, jokes, and tall tales.

The pop-up space can display a behind the scenes commentary about its images or moving images (not shown).

The images and moving images can be used to augment the other meanings in the pop-up space. The images and moving images can be presented alone or by themselves without any other meanings in the pop-up space. Ideally, the mode used best helps a person to understand the selected word.

All of the meaning features in the pop-up space described above are hereinafter “meaning” and “meanings”.

The signify function, for the correct contextual meaning, can include and is not limited to highlighting using various colors, encircling, using distinctive icons, coloring the words or images, using larger font sizes, using distinctive fonts, having an animated character gesturing, and any other distinguishing functions or features that signify.

The pop-up space can include and is not limited to literary criticisms, literary reviews, literary summaries, criticisms, reviews, summaries, narratives, historical information, symbolic significances, interpretations, reinterpretations, alternative interpretations, revisionist histories, commentaries, motifs, themes, connotations, and to give different perspectives about the selected word.

The computer's sound system can be utilized to produce sound meanings, such as for the pronunciation of the selected word, sentence, text, pop-up space meanings, and optional related trivia. In addition the sound meanings can include and are not limited to music, voices, jingles, narrations, voice-overs, and an exact audio reading and spelling. The sound meanings can be about the selected word, the text, the associated information, and the other meanings in the pop-up space. The sound meaning can even be a vocal explanation of the correct contextual meaning. The sound effects can be produced by selecting, for example, a displayed speaker icon.

The pop-up space can have a menu with at least two choices or options to present the meanings and optional related trivia in an organized manner. Additional selections are necessary to choose the choices on the menus. The drag and selection, which slides the cursor from one location to another location, can be utilized to make a choice.

Next is a description of an optional complementing or complementary related trivia. The related trivia is a trivial type of information. While the pop-up space meanings and its educational correct contextual meaning like a definition is highly important, the optional related trivia information is inherently unimportant. Since the related trivia is trivial information, it is non-obvious in contrast to the high-valued educational correct contextual meaning. The related trivia does have educational qualities, however trivial.

The trivia can be related to the associated information on a screen, or related to the selected words, or related to the pop-up space meanings such as an etymology or a moving image. The trivia can even be related to the original trivia itself or any other trivia. The optional complementary related trivia is hereinafter “trivia” unless described otherwise.

The trivia can be presented in the pop-up space, or it can be presented outside of the pop-up space. The examples of the latter includes and is not limited to displaying the trivia next to the selected word, next to the pop-up space, next to the associated information, next to the text, at the top or bottom of the screen, and in its own pop-up space.

The trivia challenges a person and is engaging and entertaining. The trivia is not only fun but the person may learn something new. The trivia enlivens the dry and boring experience that is often a part of education.

The trivia can be presented in many formats, and includes and is not limited to the following example formats.

One interactive format has a trivia question with multiple choice answers, and when a choice is selected the result is shown. The result is correct or incorrect. Another format has a true or false trivia question, and when one is selected the result is shown. The true or false format can be duplicated to a yes or no format or other like formats. Another format has a trivia question, and when an answer is entered into an input field the result is shown.

Another format has a trivia question with a hint feature that display the hint information, or display variations of a “hint” link that can be selected to show the hint information. Another format has a series of trivia questions and answers, then showing a score result. Another format has a statement, sentence, partial statement or partial sentence instead of a question.

Another format asks for more than one answer and displays the more than one correct answers and at least one incorrect answer in a multiple choice format. Another format asks for more than one answer and the answers are entered an input field, or typed on the screen. Another format displays interesting, amusing trivia information that is non-interactive, or without the response, answer, or input features.

The next feature is a source (not shown) of the meanings and features in the pop-up space and trivia. One source can be from published and professional reference works that includes and is not limited to dictionaries, almanacs, encyclopedias, subject oriented encyclopedias, compilations, subject oriented dictionaries, subject oriented summaries, reviews, criticisms, treatises, photography encyclopedias, movie encyclopedias, maps, directories, and thesis publications. Any other reference works that are a source of the pop-up space meanings and trivia can be utilized.

Other sources can include and are not limited to databases, emerging or trending slang, emerging science, emerging research, all communications mediums, and extemporaneous works. The database sources includes and are not limited to servers, internet databases, network databases, computer storage devices, computer-readable devices, as well as databases, hard drives, memory from the computers of organizations, computer plug-ins, pc cards, and flash cards.

The communications mediums sources includes and are not limited to paper, digital media, published materials, art works, photography, zoetropes, phonograms, vinyl records, tape cassettes, cassettes, videocassettes, telephone, radio, television, movies, electronic hardware, CDs, DVDs, portable playable, and recording devices.

The extemporaneous works sources are productions or works from the ad hoc creativity of people. These includes and are not limited to writers, editors, artisans, illustrators, artists, painters, photographers, filmmakers, directors, producers, cameramen, actors, singers, deejays, dancers, and musicians.

The different sources can be mixed together in combination.

The pop-up space meanings and the trivia can be shown in large sized font, large sized text, and in enlarged images or moving images (not shown) that are helpful for the visually impaired. For easier viewing, the colors and contrast of the meanings and the trivia can be enhanced and adjusted.

A captions or subtitles (not shown) can be displayed which parallel the sound effects of the pop-up space meanings and the trivia that are helpful for the hearing impaired. The captions or subtitles can play whether the sound is on or off. The captions or subtitles can be shown outside of the pop-up space. The examples of this includes and is not limited to displaying them at the bottom of the screen, next to the selected words, next to the associated information, next to the pop-up space, and next to the trivia.

The signified correct contextual meaning and the trivia cooperate to make learning about words more educating and exciting. The signified correct contextual meaning and entertaining trivia adds value and increases the popularity of a digital application, digital property, and digital product or service.

It is emphasized that all of the above features and pop-up space meanings, including the trivia, are not required to be used at the same time. The features include those described in the next section on additional embodiments. However a minimum of a selected word, at least two meanings for the selected word, and a signified contextual meaning is required.

The features, different meaning types, and trivia are options. Ideally the options used are to best help a person understand, in particular, the signified correct contextual meaning of the selected word since it has more than two meanings. The options can also be used to best help a person understand, learn, be educated, and be more informed about the selected word, the sentence, the text, the associated information, the pop-up space meanings, and the trivia. The options used can depend, to a large extent, on the age, language, and makeup of an audience. The wishes of writers, directors, artists, editors, producers, executives, and other people can be factors.

### Description of Additional Embodiments

An additional embodiment is that the pop-up space's two or more meanings can be at least two different meaning types. For example, one meaning is a dictionary entry and one meaning is an image.

Another additional embodiment is that the pop-up space meanings and trivia can be calibrated to a level of difficulty and sophistication with respect to an age of an intended audience (not shown). Some broad categories loosely define the age groups. The categories includes and are not limited to pre-school, elementary school, junior high school, high school, young adults, adults, twenty-something, thirty-something, and seniors audiences.

Another additional embodiment is that the pop-up space meanings and trivia can be customized with respect to an intended occupational audience (not shown). There are innumerable occupations that includes and are not limited to physicians, HVAC professionals, computer programmers, carpenters, airplane pilots, and organic biologists.

Another embodiment involves pop-up spaces within pop-up spaces. Any of the pop-up space meanings and trivia themselves can be selected to trigger their own latent pop-up space or trivia (not shown). These pop-up space meanings and trivia can have their own distinctive signals to denote that the latent pop-up space or trivia is available. The additional trivia can be unrelated to anything on the screen or it can be related to the associated information on the screen, or related to the selected words, or related to the selected pop-up space meanings or trivia, or any other trivia. Theoretically this can be repeated indefinitely. However information overload and screen space constraints will likely limit this practice to a few times.

Another additional embodiment is that the text and associated information displayed on the screen are in a different language or dialect than the language or dialect of the pop-up spaces and trivia.

Another additional embodiment is that the pop-up spaces and trivia can use at least two different languages from among all the languages of the world, past and present. The language embodiments benefits a person interested in learning about a different language.

Thus the current application helps a person learn about the correct contextual meaning when there is more than one meaning for a word in a sentence. The process uses a fast selecting step, convenient pop-up space, and the signify function. The pop-up space presents a plethora of the very useful educational meanings, features, and the signified correct contextual meaning. Furthermore the person is entertained and challenged by the fun and exciting trivia. The assembled process is basic and compact.

The advantages of the embodiments are numerous.

### Advantages

A number of advantages of some embodiments of the current application are:
(a) to display the process on the computer screen in a fast and convenient manner;
(b) to place a distinctive signal on or next to a word or phrase in a sentence to denote that a latent pop-up space exists for the signaled word;
(c) when the word is selected this triggers the pop-up space with two or more meanings and one of the meanings is the correct contextual meaning and is signified;
(d) the correct contextual meaning signified is from the work and expertise of, for example, writers, editors, editorial staff, copy-editors, proofreaders, producers, directors, web masters, designers, and programmers;
(e) the signify function can highlight, encircle, use colors, use distinctive icons, or use any other distinguishing signifiers;
(f) fun complementary related trivia is optionally displayed;
(g) the pop-up space meanings can be dictionary entries or other reference materials;
(h) the examples of dictionary entries are definitions, senses, syllable breaks, pronunciations, parts of speech, etymologies, variants, usages, and idioms;
(i) the pop-up space meanings can be images such as photographs, illustrations, paintings, drawings, comics, charts, maps, and diagrams that convey a meaning for the selected word, or the other pop-up space meanings, or the trivia;
(j) the pop-up space meanings can be moving images such as films, videos, animation, claymation, stop-action, cartoons, and computer generated imagery that convey a meaning for the selected word, or the other pop-up space meanings, or the trivia;
(k) providing additional subsequent pop-up spaces for the selected word through subsequent selections;
(l) a sound system can be utilized to produce sound effects such as pronunciations, music, and narrations for the pop-up space meanings or the trivia;
(m) when a meaning in the pop-up space or the trivia is selected, to display their own pop-up space meaning or trivia;
(n) the meanings in the pop-up space has their own distinctive signal to denote that a latent pop-up space exist for them;
(o) the pop-up space meanings can be at least two different types of meanings such as one dictionary definition and one cartoon;
(p) the trivia can be related to the associated information on the screen, or the selected words, or the pop-up space meanings, or the original trivia itself, or any other trivia;
(q) the challenging trivia can be presented in varied formats, for example, a series of questions with multiple choice answers and a final score;
(r) the signified correct contextual meaning and entertaining trivia adds value and increases the popularity of a digital product or service;
(s) to calibrate the level of difficulty of the pop-up space meanings and features or the trivia with respect to the age of the intended audience;
(t) to customize the pop-up space meanings and features or the trivia with respect to the occupation of the intended audience;
(u) the sources of the pop-up space meanings and features or the trivia can be from reference works, databases, any communications mediums, and extemporaneous works;
(v) the text and associated information displayed on the screen is in a language that is different than the language of the pop-up spaces or trivia;
(w) the pop-up spaces or trivia uses at least two different languages; and
(x) the many pop-up space meaning types, the many other features, or the trivia are options that can be presented to best assist a person to learn about the signified correct contextual meaning of words or phrases with more than one meaning.

These and other advantages of one or more embodiments are apparent from a consideration of the above description and accompanying drawings.

### CONCLUSION, RAMIFICATIONS, AND SCOPE

Accordingly the current application provides a fast process in which a user simply selects words or phrases in a sentence displayed on a computer screen. The optional complementary related trivia can be displayed. The convenient pop-up space appears instantly nearby to present the two or more meanings of the selected word.

The two or more meanings of the selected word can be dictionary entries like definitions, other reference materials, images, and moving images among other meaning types.

One of the meanings is the correct contextual meaning and is signified. The signified correct contextual meaning is based on the work and expertise, for example, of writers and editors. The always popular and fun trivia makes the learning experience more enjoyable.

Although the above description contains many specificities, these should not be construed as limiting the scope of the embodiments, but as merely providing exemplifications of some of the embodiments. Many other variations are possible.

For example instead of limiting the pop-up spaces to the above described meanings and features, more and different features can be implemented in or outside of it such as a blog, surveys, rating input, save function, email function, and social media services.

Thus the scope of the embodiments should be determined by the appended claims and their legal equivalents, rather than by the examples given.

I claim:

1. A process, comprising:
(a) providing a computer,
(b) providing a screen of said computer,
(c) utilizing a selection method of said computer,
(d) utilizing a word displayed on said screen,
(e) implementing at least two meanings of said word,
(f) indicating one meaning of said at least two meanings is a signified correct contextual meaning of said word, and
(g) enabling said selection method for a user to select said word displayed on said screen of said computer and triggers the display of said at least two meanings of said word on said screen, since heretofore said one meaning of said at least two meanings is said signified correct contextual meaning of said word, said screen also displays said signified correct contextual meaning of the selected word.

2. The process of claim 1 further including enabling a pop-up space to present said at least two meanings of said word and said signified correct contextual meaning of said word.

3. The process of claim 1 wherein said signified correct contextual meaning is highlighted.

4. The process of claim 1 wherein said at least two meanings is at least one definition for said word.

5. The process of claim 1 wherein said at least two meanings is at least one part of speech for said word.

6. The process of claim 1 wherein said at least two meanings is at least one dictionary sense for said word.

7. The process of claim 1 wherein said at least two meanings is at least one dictionary entry for said word.

8. The process of claim 1 wherein said at least two meanings is at least one reference material for said word.

9. The process of claim 1 wherein said at least two meanings is at least one picture substantially conveying a meaning for said word.

10. The process of claim 1 wherein said at least two meanings is at least one video substantially conveying a meaning for said word.

11. The process of claim 1 wherein said at least two meanings is at least one photograph or at least one computer generated imagery substantially conveying a meaning for said word.

12. A system, comprising:
a computer;
a screen of said computer;
a word or phrase displayed on said screen;
a pop-up space on said screen;
at least two meanings of said word or phrase;
a correct contextual meaning signified for said word or phrase; and
a user selects said word or phrase displayed on said screen of said computer and triggers said pop-up space on said screen that presents said at least two meanings of said word or phrase with said correct contextual meaning signified for said word or phrase.

13. The system of claim 12 wherein: said word or phrase has a distinctive signal to indicate that a latent said pop-up space exists.

14. The system of claim 12 wherein: said correct contextual meaning signified is encircled.

15. The system of claim 12 wherein: said at least two meanings is at least one definition of said word or phrase.

16. The system of claim 12 wherein: said at least two meanings is at least one dictionary sense or at least one part of speech of said word or phrase.

17. The system of claim 12 wherein: said at least two meanings is at least one dictionary entry or at least one reference material of said word or phrase.

18. The system of claim 12 wherein: said at least two meanings is at least one image or at least one moving image substantially conveying a meaning for said word or phrase.

19. The system of claim 12 wherein: said at least two meanings is at least one photograph or at least one computer generated imagery substantially conveying a meaning for said word or phrase.

20. The system of claim 12 wherein: said at least two meanings has at least one meaning that is from an extemporaneous work source.
